(19) United States
(12) Patent Application Publication
(10) Pub. No.: US 2005/0287334 A1
(43) Pub. Date: Dec. 29, 2005

(54) Cushioned flooring products

(76) Inventors: Jeffery J. Wright, Cartersville, GA (US); Barrett R. Morton, Cartersville, GA (US)

Correspondence Address: NEEDLE & ROSENBERG, P.C., SUITE 1000, 999 PEACHTREE STREET, ATLANTA, GA, 30309-3915, US

(21) Appl. No.: 10/879,884

(22) Filed: Jun. 29, 2004

(51) Int. Cl. B32B 33/00; D05C 17/02

(52) U.S. Cl. 428/95; 428/97

(57) ABSTRACT

The present invention pertains to cushioned flooring products. More particularly, the present invention pertains to cushioned carpet tiles and carpet and processes for making the same. The cushioned carpet tiles and carpet of the present invention comprise a modified secondary backing material having a scrim material and a non-woven fiber batt, where the non-woven fiber batt is made up of a plurality of fibers. The fibers of the non-woven fiber batt are needled into the scrim material so that the non-woven fiber batt is durably attached to the scrim material.

The present invention pertains to cushioned flooring products. More particularly, the present invention pertains to cushioned carpet tiles and carpet and processes for making the same.

### BACKGROUND OF THE INVENTION

Foam cushions are commonly used as backings for carpet and carpet tile products. When cushion backed, carpets and carpet tiles may wear longer than products that do not have such backings. In particular, when stress is applied to carpet face yarn affixed to a carpet or carpet tile product having a cushioned backing, such as by walking, rolling or by placing heavy objects on the surface, the load is transferred from the carpet face to the cushioned backing. Thus, the cushioned backing will bear the majority of the load and the carpet face will generally not show wear as quickly as products not having a cushion backing. As such, a cushion backing system engineered to absorb that force can greatly increase the appearance retention of the carpet or carpet tile, thus increasing its usable life and lowering the overall cost to the consumer. Additionally, since a cushion backed carpet or carpet tile product can absorb the load applied by a person's walking or standing, the person's fatigue can be lessened. This makes cushion backed carpet or carpet tile products especially beneficial in locations where persons walk or stand for extended periods such as, for example, offices, malls, airports etc.

Polyurethanes are widely used in the preparation of foam cushion backed carpet and carpet tiles. Application of a polyurethane cushion backing to a carpet or carpet tile generally enhances the longevity of the product and can decrease fatigue in a person walking or standing thereon.

However, carpet and carpet tile products backed with polyurethanes are generally not readily recyclable using low cost methods. Further, such backings, while suitable for many purposes, are prone to delamination when exposed to various forces, such as rolling traffic. Other types of backings also have problems, such as a reduced ability to recycle or other environmental issues.

In light of the above, it would be beneficial to a obtain cushion backing material for a carpet or carpet tile product, where such backing does not comprise polyurethane or other backing materials not easily recycled using conventional recycling techniques. Also, it would be desirable to obtain a cushion backing product having better delamination properties than carpet or carpet tile products available in the prior art.

### SUMMARY OF THE INVENTION

The present invention pertains to cushioned flooring products. More particularly, the present invention pertains to cushioned carpet files and carpet and processes for making the same. The cushioned carpet tiles and carpet of the present invention comprise a modified secondary backing material having a scrim material and a non-woven fiber batt, where the non-woven fiber batt is made up of a plurality of fibers. The fibers of the non-woven fiber batt are needled into the scrim material so that the non-woven fiber batt is durably attached to the scrim material. For the carpet tile aspect of the present invention, no more than about 30% of the plurality of fibers penetrate the scrim material. For the carpet aspect of the present invention, no more than about 10% of the plurality of fibers penetrate the scrim material. The modified secondary backing is applied to a carpet or carpet tile face good with an adhesive composition comprising at least one laminating adhesive. The carpets and carpet tiles of the present invention exhibit excellent delamination strength and cushioning.

Additional advantages of the invention will be set forth in part in the description that follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

The present invention may be understood more readily by reference to the following detailed description of the invention and the examples provided herein. But before the present invention is disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Throughout this application, where patents are referenced, the disclosures of these patents in their entireties are hereby incorporated by reference into this disclosure.

In this specification and in the claims that follow, reference will be made to a number of terms that shall be defined to have the following meanings:

As used in the specification and the appended claims, the singular forms “a,” “an” and “the” include plural referents unless the context clearly dictates otherwise. Thus, for example, reference to “a yarn” includes mixtures of one or more yarns, reference to “a backing” includes mixtures of one or more backings, and the like.

Often, ranges are expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where the event or circumstance occurs and instances where it does not. For example, the phrase “Optionally, the laminating adhesive may be in contact with a stabilizing material” means that the stabilizing material may or may not be present.

References in the specification and concluding claims to parts by weight of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight % of a component, unless specifically stated to the contrary, is based on the total weight of the formulation or composition in which the component is included.

As used herein, and unless the context clearly indicates otherwise, carpet and carpet tile are separate aspects of the present invention.

“Carpet” means a broadloom textile flooring product manufactured for and intended to be used in roll form. “Carpet tile” denotes a modular floor covering, usually in 18″×18,″ 24″×24″ or 36″×36″ squares, but other sizes and shapes are also within the scope of the present invention. In accordance with the present invention, it should be noted that the carpet tile aspect of the present invention does not comprise broadloom carpet that is cut into modular, i.e., tile pieces.

As would be recognized by one of ordinary skill in the art, because of their modular form, carpet tiles require a different construction from carpets. In particular, and as one example, carpets normally retain dimensional stability by stretching and affixing the structure across the length and/or width of a room. The broadloom carpet product is generally affixed to retain the carpet in a stretched form by attaching the carpet to tacks, gluing the carpet to the floor or by some other method. In contrast, for carpet tiles, dimensional stability (which means that the carpet tile backing will not experience horizontal growth or shrinkage) must be designed into the carpet tile structure itself because of its considerably smaller size and different intended uses. Also, a carpet tile must not experience cupping or curling (turning up or down of the edges) that would detract from the aesthetic and functional operation of the tile. Thus, a carpet tile is normally designed with reference to its end use as a carpet tile. Carpet tiles are normally prepared by preparing a 6 ft. width of material designed specifically for use as carpet tiles and cutting the width into the desired size for use. Since this 6 ft. length is designed for use as a carpet tile, the present invention also relates to such 6 ft. “pre-cursor” to carpet tile.

The present invention relates particularly to cushioned carpet and carpet tiles. When applied to carpet and carpet tile, the term “cushion” means a padding made as an integral part of the backing. Such padding is intended to improve the comfort of a person walking or standing on the carpet or carpet tile, as well as to improve the durability of the product by absorbing or distributing stresses imparted to the carpet or carpet tile face.

While, as noted, carpet and carpet tiles are separate aspects of the present invention, the basic structure of the face fabric of these aspects are not critical to the invention and, as such, will be discussed together.

In a first aspect of the present invention, a face fabric is provided. The face fabric can be either a tufted griege good, a fusion bonded material or a woven and needle punched material.

Whether a tufted griege good, a fusion bonded or a woven and needle punched face fabric is used, the face yarns may be made from one or more of the following fiber types: polyolefins, polyamides, polyesters, polyethylene terephthalate (PET) and polytrimethylene terephthalate (PTT). Still further, the face fabric can be one or more of: polypropylene, PET, nylon or PTT. The present invention is not limited to the selection of any specific type of fiber for the face yarn and, as such, may include other fibers, such as natural fibers.

To prepare a tufted griege good, a yarn is tufted, woven or needle punched into a primary backing. The tufting, weaving or needle punching can be conducted in any manner known to be suitable to one of ordinary skill in the art which will not be discussed in detail herein. To fix the yarn to the primary backing, an adhesive material applied to the back of the fabric. The adhesive material, generally referred to as a “precoat,” can be one of a number of materials known in the art to be suitable for such use. As non-limiting examples, the precoat material can comprise one or more of: styrene-butadiene rubber (SBR), polyvinyl chloride (PVC), ethylene vinyl acetate (EVA), polyesters, polyurethanes, polyolefins, emulsified polymers, butadiene methamethacrylic acid (BDMMA) and vinyl ester acetate (VAE). Still further, the precoat material may comprise homogenously branched ethylene polymer (HBEP) as disclosed in U.S. patent application Ser. No. 09/032,893 (the '893 application), the disclosure of which is incorporated herein in its entirety by this reference.

A primary backing is used in a tufted griege good. In the present invention, a woven or a non-woven primary backing material can be used. The type of primary backing desired will depend on various factors including, but not limited to, whether carpet or carpet tile is being made, the desired end-use for the product (e.g., commercial or residential), the type of face yarn used and the price of the product. One example of a suitable woven primary backing is 28×18 woven primary, style no. 1002764 from Synthetic Industries, Calhoun, Ga. One example of a suitable non-woven backing material is Colbond UMT 135, manufactured by Colbond, Enka, N.C. Other types of primary backings are also suitable for use herein such as, for example, hydraentangled fibers and fiberglass.

A fusion bonded face fabric is characterized by a plurality of cut pile yarns, for example, nylon or other natural or synthetic fibrous-type material, implanted in an adhesive layer, particularly a thermoplastic, like a polyvinyl chloride layer or a hot-melt adhesive layer. Where a polyvinyl chloride plastisol layer is used, heating of the layer gels and then fuses the layer into solid form, while with hot-melt adhesive material, a melted layer is applied and subsequently cooled into solid form. The plurality of fibrous yarns are bonded to and extend upright from the adhesive base layer to form a face wear surface. Methods of making fusion bonded face goods are known and described, for example, in U.S. Pat. No. 6,089,007, the disclosure of which is incorporated in its entirety by this reference.

Irrespective of whether a tufted griege good or a fusion bonded material (or other suitable type) is used as the face fabric in the present invention, an adhesive composition is used to affix the face fabric to the modified secondary backing. The adhesive composition comprises at least one laminating adhesive.

In accordance with the present invention, a number of materials can be used as the laminating adhesive. In some aspects, the laminating adhesive can comprise one or more of a polyolefin such as HBEP, LLDPE (linear low density polyethyelene), ULDPE (ultra low density polyethylene), HDPE (high density polyethylene), MDPE (medium density polyethylene), low density polyethylene (LDPE), polypropylene (including atactic polypropylene), PVC, hot melt adhesives, SBR, BDMMA or VAE. Still further, the laminating adhesive can comprise HBEP. Yet still further, the laminating adhesive can comprise any adhesive material that is capable of adhering the face fabric material to the modified secondary backing and providing the delamination values claimed herein.

The laminating adhesive can be present in the adhesive composition at from about 5 to about 95% by weight of the adhesive composition. Still further, the laminating adhesive can be present in the adhesive composition at from about 10 to about 40%, or from about 15 to about 30% by weight of the adhesive composition. As would be recognized by one of ordinary skill in the art, the amount of laminating adhesive to be included in the adhesive composition will be largely dependent on the type of laminating adhesive used to attach the face fabric to the modified secondary backing. The suitable amount needed to accomplish this can be determined by one of ordinary skill in the art without undue experimentation.

Yet still further, the adhesive composition can comprise a laminating adhesive (as defined above) and a second polymer material. The second polymer material can comprise one or more of: HBEP, ULDPE, LDPE, LLDPE, ULDPE, MDPE, HDPE, grafted polyethylene (e.g. a maleic anhydride extrusion grafted heterogeneously branched linear low density polyethylene, high density polyethylene, or a maleic anhydride extrusion grafted homogeneously branched ultra low density polyethylene), ethylene acrylic acid copolymer, ethylene vinyl acetate copolymer, ethylene ethyl acrylate copolymer, polystyrene, polypropylene, polyester, polyurethane, polybutylene, polyamide, polyvinyl butyral, polycarbonate, rubbers, ethylene propylene polymers, ethylene styrene polymers, styrene block copolymers, vulcanates, SBR, hot melt adhesive, BDMMA or VAE. Still further, the second polymer material can be any material that is suitable for blending with the laminating adhesive so as to enhance or moderate the resulting delamination strength of the carpet or carpet tile. As would be recognized by one of ordinary skill in the art, whether a second polymer material is to be included and, if so, in what amount, will be largely dependent on the type of laminating adhesive used in the adhesive composition. The suitable amount needed to accomplish this can be determined by one of ordinary skill in the art without undue experimentation.

In some aspects, such as when maleic anhydride is used as the second polymer material, the second polymer material can be grafted onto a polyolefin laminating adhesive and the grafted polymer used neat or the grafted material may be added to the bulk polymer. The second adhesive material can be present in the laminating adhesive at from about 0.5 to about 30 weight %, or from about 1 to about 20 weight %, or from about 5 to about 15 weight %, based on the total weight of the laminating adhesive. When maleic anhydride is used with a polyolefin laminating adhesive, the final maleic anhydride concentration in the adhesive composition can be from about 0.01 to about 0.5 weight %, or from about 0.03 to about 0.2 weight %, based on the total weight of the adhesive composition.

When mixing the laminating adhesive with a second polymer material or grafting a polymer material to the laminating adhesive, suitable methods known to one of ordinary skill in the art, such as those disclosed in the '893 application (previously incorporated by reference) can be used.

In further aspects, a polyurethane material can be used as the laminating adhesive. When a polyurethane material is used as the laminating adhesive, known methods of applying such materials to carpet tile products may be used. Such methods and materials are disclosed, for example, in U.S. Pat. Nos. 4,296,159, 5,104,693 and 6,299,715, the disclosures of which are incorporated herein in their entireties by this reference.

Irrespective of the type of laminating adhesive, the adhesive composition can contain flame retardants, colorants, tackifiers, or other materials that would be useful to, for example, improve processability, aesthetic properties, etc.

In a significant aspect, the laminating adhesive may contain a filler derived from a recycled material. In particular, a filler can be desirable to reduce the amount of laminating adhesive required and to, in some aspects, vary the performance of the adhesive composition. To this end, a filler obtained from a recycled source can be used. While several types of recycled filler material are known, fly ash is particularly suited to use in the present invention. Use of fly ash can increase the amount of recycled content (as defined later herein) in the finished carpet tile when recycled content is used as the cushion backing material.

Methods of incorporating fly ash into polyolefin compositions, such as HBEP, are disclosed in U.S. Pat. No. 6,472,042, the disclosure of which is incorporated herein in its entirety by this reference. Methods of incorporating fly ash into polyurethane compositions are disclosed in U.S. Pat. Nos. 6,555,199 and 6,096,401, the disclosures of which are incorporated herein it its entirety by this reference.

If significant recycled content is not desired in the adhesive composition, other types of filler products known by one of ordinary skill in the art for use with the types of materials suitable for the laminating adhesive can be used. For use with polyolefin laminating adhesives, suitable filler materials are disclosed in the '893 application incorporated herein above. For use with polyurethane laminating adhesives, suitable filler materials are disclosed in U.S. Pat. Nos. 4,296,159, 5,104,693, and 6,299,715, incorporated herein above.

The filler material, whether recycled or otherwise, can be present in an amount suitable to obtain the exemplary delamination values claimed in some aspects herein. For polyolefin laminating adhesives, the amount of filler can be from about 10% to about 80% by weight, as measured by the total weight of the adhesive composition, that is, the total weight of the laminating adhesive, second polymeric material (if any), and any further materials (such as filler, processing aides etc.). For a polyurethane laminating adhesive, the amount of filler can be from about 10 to about 80% by weight as measured by the total weight of the adhesive composition. Still further, in the adhesive composition, the amount of filler can be from about 5, 10, 15, 20, 25, 30, 35, 40, 45, 50, 55, 60, 65, 70, 75, 80, 85, 90 or 95% by weight, as measured by the total weight of the adhesive composition, where any value can form an upper or a lower endpoint, as appropriate.

In some aspects, a stabilizing material can be in contact with the adhesive composition so as to enhance the dimensional stability of the finished carpet or carpet tile product. The stabilizing material can be embedded or partially embedded in the laminating adhesive as described further herein.

To obtain an embedded stabilizing material, the adhesive composition can be applied in two passes whereby a layer of adhesive composition containing a laminating adhesive (such as HBEP) is applied to the back side of the face fabric, for example, using a extrusion process, such as disclosed in the '893 application. A stabilizing material can then be placed in contact with the not-yet-solidified adhesive composition, followed by application of additional adhesive composition in a second pass. Such a process is suitable, for example, in embedding non-woven fiberglass into the carpet or carpet tile structures of the present invention.

When polyurethane (or other types) of materials are used as the laminating adhesive, methods appropriate for embedding a stabilizing material in the adhesive composition, which are known to one of ordinary skill in the art, may be used as appropriate. Such methods are also disclosed in U.S. Pat. Nos. 4,296,159, 5,104,693 and 6,299,755 patents incorporated previously herein.

The stabilizing material can also be embedded in the adhesive composition if the stabilizing material is of a construction that can allow the stabilizing material to penetrate the adhesive composition prior to solidification (as with a polyolefin) or prior to curing (as with polyurethane). One example of such a construction is Bayex® which is an open weave and somewhat porous fiberglass material manufactured by Saint-Gobain Technical Fabrics, (Niagara Falls, N.Y.).

Yet still further, the stabilizing material can be embedded or partially embedded in the adhesive composition if the adhesive composition and/or the stabilizing material exhibit properties that will allow the stabilizing material to “sink” into the adhesive composition prior to solidification or curing of the composition. In such aspects, the adhesive composition will be of suitable viscosity and/or density to allow the stabilizing material to become embedded or partially embedded in the composition prior to solidification or curing.

As noted, the adhesive composition adheres the modified secondary backing to the fabric face. The amount of the adhesive composition used is that amount sufficient to provide the delamination values claimed herein. In some aspects, the adhesive composition is added to the face fabric at from about 10 to about 80 oz/sy (ounces/square yard). Still further, the adhesive composition is applied at from about 5 to about 40 oz/sy, or from about 10 to about 20 oz/sy for carpet. Still further, the adhesive composition is applied at from about 10 to about 60 oz/sy, or from about 30 to about 50 oz/sy for carpet tile. The adhesive can be added in one or more passes.

The modified secondary backing utilized in the present invention comprises an integrated scrim formed by joining a conventional woven secondary backing fabric to a layer of fiber batt or non-woven fabric prepared from fiber batt. Notwithstanding the reference to “conventional woven secondary backing fabric,” practice of the present invention is not limited to any particular type of secondary fabric in that woven, knitted, point bonded, thermal fused with use of low melted fibers and other secondary backing types may be used to manufacture a suitable modified secondary backing. One particularly suitable secondary backing type for use in the present invention is a leno weave (16×5 pick) secondary backing made from polypropylene. Such a material is available from Synthetic Industries.

The fiber batts and non-woven materials suitable for use herein can be manufactured from synthetic materials derived from virgin or recycled materials or a mixture thereof. Natural fiber may be used, including cotton. Polyolefin materials can be used, including polyethylene and polypropylene. Still further, polyester and nylon materials can be utilized in the present invention. Mixtures of these fibers types may be used. Bicomponent fibers may also be used.

In a significant aspect of the present invention, the modified secondary backing can utilize recycled polymeric fibrous materials in the manufacture of the non-woven backing aspect of the modified secondary backing. In one particular aspect, the non-woven fibers are derived from post-consumer recycled material. In further aspects, the non-woven fibers are derived from both pre- and post-consumer recycled material. The fibers can also be derived from pre-consumer recycled material. In additional aspects, the fibers consist essentially of post-consumer recycled material. Yet still further, the non-woven fibers are derived from primarily 100% post-consumer recycled material. Still further, the non-woven fibers consist essentially post-consumer recycled material.

The post-consumer recycled material is obtained from known methods, such as the recycling of polymeric (e.g., PET) beverage containers. The pre-consumer recycled material is obtained from known methods, such as the diversion of manufacturing waste.

The non-woven material can include anti-microbial and/or anti-static properties. A product having anti-microbial properties would be useful in “clean” environments such as hospitals, food handling/processing areas, health clubs, locker rooms and the like. Similarly, products having anti-static properties would be useful in the electronics industry where control over static electricity can be significant.

As would be recognized by one of ordinary skill in the art, non-wovens are produced by many different processes, but each has three general steps in common: web forming, web bonding and fabric finishing. Methods of forming non-woven fabrics useful in the modified secondary fabric aspect of the present invention are disclosed in, for example, U.S. Pat. Nos. 6,344,254 and 6,060,145 (the “'254” and “'145” patents, respectively), the disclosures of which are incorporated herein in their entireties by this reference.

The fiber batt is used in the modified secondary backing material joined with the secondary backing fabric (i.e., scrim) by mechanical bonding, particularly by needle punching. Again, such methods are disclosed in detail in the '254 and '145 patents and will not be discussed in detail herein.

As noted in the '145 and '254 patents, the needles must penetrate through the non-woven fibers first and then into the scrim. The inventors herein have found that the degree of penetration disclosed as significant in the '145 and '254 patents is not necessary to obtain effective delamination values of the fabric face to the modified secondary backing.

That is, a significant difference between the disclosures of the '254 and '145 patents and the present invention relates to the degree of penetration of the non-woven material into the secondary backing. For carpet backings, the '254 and '145 patents state that it is significant that approximately 70% of the fibers should stay on the needle side (or floor side in the finished carpet) of the scrim. Such an orientation is stated to allow the scrim to have “intimate contact” with the adhesive therein during carpet manufacture to thereby increase delamination strength and to add stability to the carpet. For carpet tile backings, the '145 and '254 patents state that a greater concentration of fibers (for example 70%) should be on the side of the modified secondary backing in contact with the adhesive. Put another way, for carpet tiles, the '145 and '254 patents indicate that it is important that only 30% of the fibers be present on the floor side of carpet tile. This would leave only a thin layer of non-woven material on the side of the carpet tile facing the floor. Such a thin layer is not suitable to provide a cushion carpet tile acceptable to the consumer.

In the carpet tile aspect of the present invention, no more than about 30% of the fibers penetrate the secondary backing fabric so as to be on the adhesive composition side of the modified secondary backing (that is, on the side away from the floor side). Still further, no more than about 30, 25, 20, 15, 10 or 5% of the fibers penetrate the secondary backing fabric so as to be on the adhesive composition side of the modified secondary backing, where any of these values can form an upper or a lower endpoint, as appropriate.

In the carpet aspect of the present invention, no more than about 10% of the fibers penetrate the secondary backing fabric so as to be on the adhesive composition side of the modified secondary backing (that is, on the laminating adhesive side). Still further, no more than about 7% of the fibers penetrate the secondary backing fabric so as to be on the adhesive composition side of the modified secondary backing.

Even with the markedly lower penetration of non-woven fibers through the scrim fabric, it has been found that with use of the adhesive compositions disclosed and claimed herein, surprisingly good delamination values have been obtained. Such delamination values are unexpected because the '145 and '254 patents expressly state that good delamination values will not be obtained without a significantly greater amount of fiber penetration through the scrim fabric.

Moreover, when carpet tiles are being prepared, surprisingly good cushioning is obtained in the present invention. That is, with reference to the carpet tile aspects discussed in the '145 and '254 patents, one of ordinary skill in the art would recognize that with only about 30% of the non-woven fiber batt on the floor side of the tile, a commercially acceptable carpet tile could likely not be obtained.

In further aspects, whether used for carpet or carpet tiles, the modified secondary backing material has a scrim weight and a non-woven fiber batt weight. In such aspects, the scrim can have a number of weights, such as from about 0.5 to about 20 oz/sy. Still further, the scrim can have a weight of about 1, 2, 3, 5, 7, 10, 12, 15, 17 or 20 oz/sy, where any value can form an upper or a lower endpoint, as appropriate.

The non-woven fiber batt can be from about 10 oz. to about 80 oz/sy. Still further, the non-woven fiber batt can be 10, 15, 20, 25, 30, 35, 40, 45, 50, 55, 60, 65, 70, 75, 80, 85, 90 or 95 oz/sy. Yet still further, the weight of modified secondary backing is measured in relation to the total weight of the backing. For example, the total weight of the modified secondary backing can be less than about 20 oz/sy, where any value can form an upper or a lower endpoint, as appropriate.

In accordance with the present invention, the total weight of the modified secondary backing (and the individual weight of the non-woven fiber batt and the scrim), is limited only by the requirements that a cushion backing be obtained as defined herein and by the level of delamination seen with the present invention.

The modified secondary backing fabric can have a thickness of from about 0.05 to about 0.5 inches. Still further, the modified secondary backing fabric can have a thickness of from about 0.1, 0.15, 0.20, 0.25, 0.30, 0.35, 0.40, 0.45, 0.50 or 1.0 inches, where any value can form an upper or a lower endpoint, as appropriate.

As noted, even with a significantly reduced penetration of non-woven fibers into the scrim of the modified secondary backing, excellent delamination values are obtained in the carpet and carpet tile aspects of the present invention. In aspects of the present invention, the delamination values of the carpet or carpet tiles are at least about 15 pounds/inch as measured by ASTM D3936-02. (The disclosures of this and other ASTM methods referred to herein are incorporated in their entireties by this reference.) Still further, delamination values of the carpet and carpet tiles of the present invention are at least about 20 pounds/inch as measured by ASTM D3936-02. As would be recognized by one of ordinary skill in the art, lower delamination values represent a tendency of a carpet or carpet tile to separate, usually at the interface between the carpet layers. Delamination is highly undesirable and represents an absolute failure of the product.

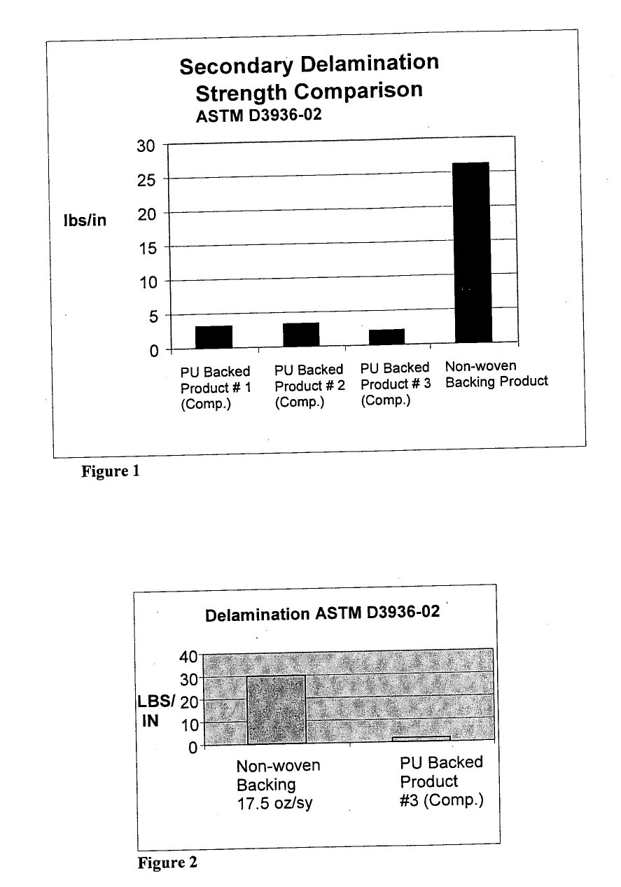

As shown in FIGS. 1 and 2, commercial polyurethane backed carpet tiles exhibit significantly lower delamination values than those seen with the carpet tiles of the present invention. Such values demonstrate a markedly improved tendency of the carpet tiles of the present invention to resist delamination. In particular, in comparison to existing cushion backed carpet tiles, the carpet tiles of the present invention show superior delamination strengths. These superior delamination values are also believed to result in carpet tiles.

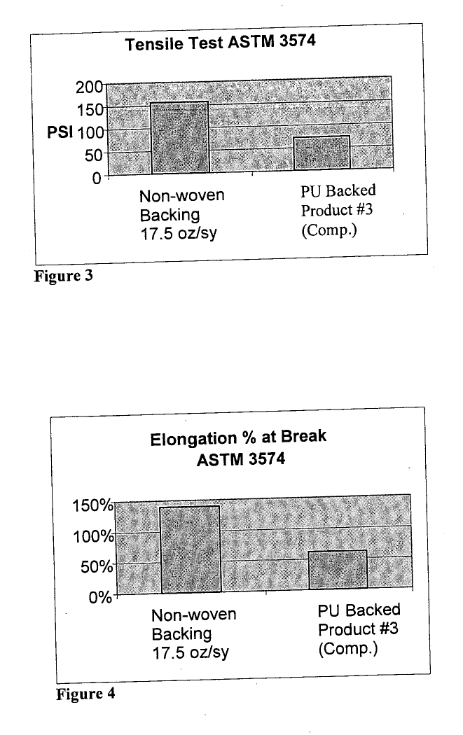

As shown in FIGS. 3 and 4, the tensile strength and elongation % at break of carpet tiles having the modified secondary backings of the present invention are significantly higher than polyurethane backed carpet tiles, where such properties are measured by ASTM 3574. This indicates that the carpet tiles of the present invention are strong and durable in comparison to polyurethane carpet tiles.

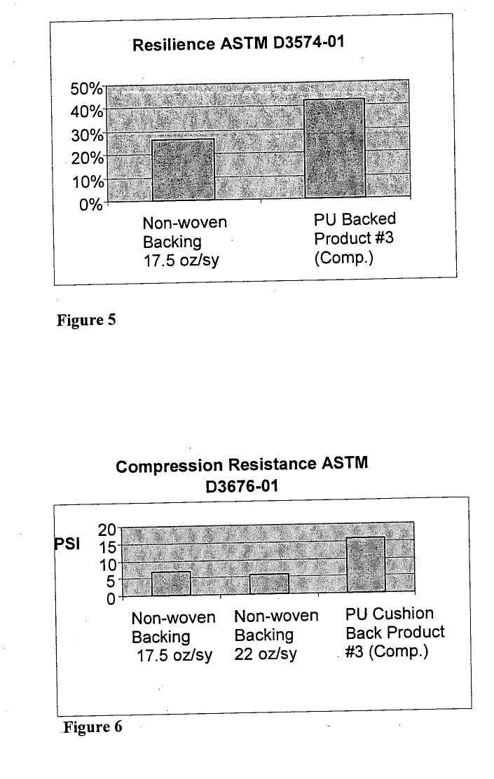

As shown in FIG. 5, carpet tiles backed with the modified secondary backing of the present invention exhibit decreased resilience over polyurethane carpet tiles as measured by ASTM D3574-01. However, as shown in FIG. 6, carpet tiles backed with the modified secondary backing of the present invention exhibit significantly improved compression resistance over polyurethane backed carpet tiles as measured by ASTM D 3676-01. As would be recognized by one of ordinary skill in the art, a measurement of cushion in carpet and carpet tiles involves a review of both resilience and compression resistance. Resilience is a measurement of the rebound provided by a carpet or carpet tile product and generally correlates to the “springiness” of a carpet or carpet tile product when a person steps thereon. Compression resistance measures the tendency of the carpet or carpet tile product to stay compressed when stepped on. If something has a high tendency to compress, the product will generally result in a greater fatigue to the person stepping on the carpet or carpet tile product.

Although the carpet and carpet tile products of the present invention have a lower resilience than polyurethane products, the lower compression resistance of the products of the present invention over polyurethane products results in the carpet and carpet file products of the present invention exhibiting excellent cushioning. Such cushioning is at least equivalent to and, in some aspects, superior to the cushioning provided by polyurethane backed carpet and carpet tiles. Moreover, the carpet and carpet tiles of the present invention have been found to provide excellent cushioning properties heretofore unknown with prior art products not made from foamed backing materials. Since the cushion products of the present invention may be prepared using non-woven fibers prepared from post-consumer recycled material, the present invention provides a further improvement over polyurethane backed products.

In some aspects, the carpet and carpet tiles of the present invention have a resilience of at least about 15% as measured by ASTM D3574-01. In further aspects, the carpet and carpet tiles of the present invention have a resilience of at least about 20% as measured by ASTM D3574-01. Still further, the carpet and carpet tiles of the present invention have a compression resistance of less than about 15 PSI as measured by ASTM D3576-01. Yet still further, the carpet and carpet tiles of the present invention have a compression resistance of less than about 10 PSI as measured by ASTM D3576-01. In a further aspect, the carpet and carpet tiles of the present invention have a combination of resilience and compression resistance properties that provide cushioning properties that are comparable or superior to existing polyurethane cushion carpet and carpet tile products.

The remainder of the modified secondary backing manufacturing process is as disclosed in the '145 and '254 patents, which was previously incorporated herein by reference in its entirety.

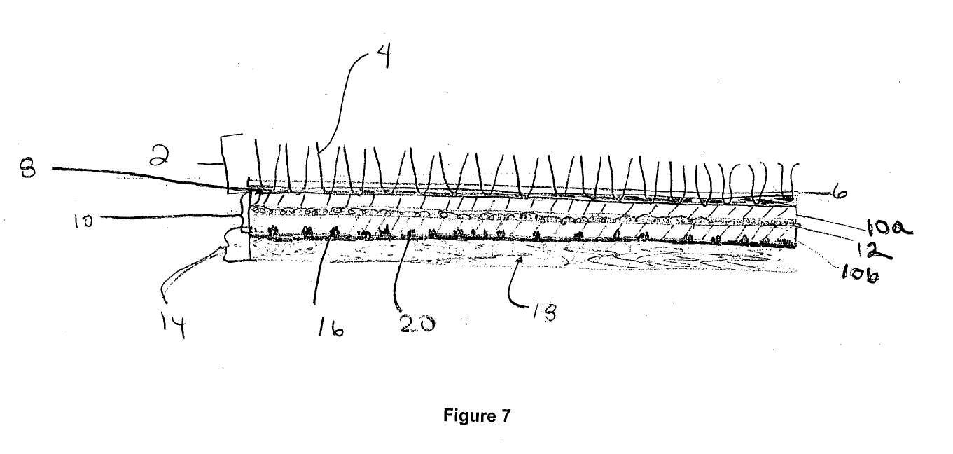

Referring now to FIG. 7, in one non-limiting aspect, a carpet tile according to the present comprises a tufted griege good face fabric 2 having a yarn 4 tufted into a non-woven primary backing 6. On a bottom side of the face fabric 2, a precoat 8 is in contact with the tufted yarn 4 so as to durably adhere to the yarn 4 to the primary backing 6. A stabilizing material 12 is fully embedded in the adhesive composition 10 by extruding the adhesive composition 10 in a first amount 10a, followed by a second adhesive composition amount 10b applied after placement of the stabilizing material 12 onto the first amount of the adhesive composition 10a. A modified secondary backing 14 is in contact with the second amount of the adhesive composition 10b. This modified secondary backing 14 has a scrim material 16 and a non-woven fiber batt 18 through which not more than about 30% of non-woven fibers 20 penetrate the scrim 16 so as to be in contact with the adhesive composition 10.

The following examples are put forth so as to provide those of ordinary skill in the art with a complete disclosure and description of how the present invention is practiced, and associated processes and methods are constructed, used, and evaluated, and are intended to be purely exemplary of the invention and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° F. (Fahrenheit) or is at ambient temperature, and pressure is at or near atmospheric.

### EXAMPLE 1

A tufted griege good face fabric having a conventional nylon 6 fiber and a non-woven primary backing (UMT 135 from Colbond) was laminated to a modified secondary backing having about 5% of its fibers penetrating the scrim material. The modified secondary backing was prepared according to the method disclosed in the '145 and '254 patents, incorporated elsewhere herein, however the needlepunching was conducted so that only about 5% of the non-woven fibers penetrated the scrim material.

As shown in FIGS. 1-6, the modified secondary backings each had a 2.1 oz/sy scrim material. One modified secondary backing type was needlepunched to provide a 17.5 oz/sy total weight of modified secondary backing. A second modified secondary backing was prepared to provide a 22 oz/sy total weight. The scrim material for both modified secondary backing was a 16×5 leno weave material having a weight of 2.1 oz./sy. The fiber for the leno weave was polypropylene. The non-woven material was 100% post-consumer recycled PET staple fiber having a length of 4 inches and a denier per filament of 10 was used for the non-woven fiber batt. The weight was 15.4 oz./sy. +/−5% of the non-woven fiber weight. The thickness was 0.160 inches (±0.01 inches) and 79 inches across. The manufacturer of both types of modified secondary backing material was Synthetic Industries of Calhoun, Ga.

An HBEP containing (Affinity®, Dow Chemical, Freeport, Tex.) adhesive composition having 60% of a class C flyash material (Boral Materials Technologies, San Antonio, Tex.) was extruded in a first pass onto the back of the griege good at 22 oz/sy. A conventional non-woven fiberglass having a weight of 2.4 oz/sy was laid down in the still-molten adhesive composition. Immediately thereafter, a second pass of the HBEP containing adhesive composition was applied 22 oz/sy to the exposed surface of the stabilizing material. The modified secondary backing having about 5% of fibers penetrating the scrim was placed in contact with the still-molten second pass of adhesive composition. When sufficiently cooled, the 6 ft. carpet structure was cut into carpet tiles.

The carpet tiles made according to the above method were examined for various properties as shown in FIGS. 1-6.

Key to FIGS. 1-6:

Non-woven backing: carpet tiles of present invention having about 5% fiber penetration and HBEP containing adhesive composition of Example 1
22 oz/sy=
2.1 oz/sy leno weave scrim material
19.9 oz/sy 100% post-consumer recycled PET fibers
17.5 oz/sy=
2.1 oz/sy leno weave scrim material
15.4 oz/sy 100% post-consumer recycled PET fibers
PU Backed Product # 1:
NexStep® Cushion Tile (Bentley Prince Street, Los Angeles, Calif.)
PU Backed Product # 2:
Comfort Plus® (Milliken & Company, Spartanburg, S.C.)
PU Backed Product # 3:
Ergoflex® Carpet Tile (Shaw Industries, Dalton, Ga.)

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

Throughout this specification, various patents, applications and publications are referenced. Each of these are incorporated herein in their entireties by this reference.

1. A cushion carpet tile comprising:
a) a face fabric having a face side and a back side;
b) an adhesive composition comprising at least one laminating adhesive wherein the composition is adjacent to the back side of the face fabric; and
c) a modified secondary backing in contact with the adhesive composition, wherein the modified secondary backing comprises:
i) a scrim material having needle side and a top side; and
ii) a non-woven fiber batt comprising a plurality of fibers attached to and penetrating the scrim material,
wherein no more than about 30% of the plurality of fibers penetrate the scrim material so as to be in contact with the adhesive composition, and
wherein the cushion carpet tile has a delamination strength of at least about 20 lbs/in as measured by ASTM D3936-02.

2. The cushion carpet tile of claim 1, wherein no more than about 15% of the plurality of fibers penetrate the scrim material.

3. The cushion carpet tile of claim 1, wherein the laminating adhesive comprises one or more of: HBEP, MDPE, LDPE, LLDPE, HDPE, ULDPE, polyurethane, SBR, BDMMA, hot melt adhesive, polypropylene, VAE, EVA, PVB, or bitumen.

4. The cushion carpet tile of claim 1, wherein the laminating adhesive comprises HBEP.

5. The cushion carpet tile of claim 1, wherein the adhesive composition is present at from about 10 to 80 oz/sy.

6. The cushion carpet tile of claim 1, wherein a stabilizing material is in contact with the adhesive composition.

7. The cushion carpet tile of claim 6, wherein the stabilizing material comprises one or more of: woven fiberglass, woven polyester, non-woven fiberglass, and non-woven polyester.

8. The cushion carpet tile of claim 1, wherein the scrim material comprises a leno weave material, woven material, knitted material, point bonded material or thermal fused material.

9. The cushion carpet tile of claim 1, wherein the plurality of fibers in the fiber batt comprises one or more of: polyester, polyethylene, nylon, natural fibers or polypropylene.

10. The cushion carpet tile of claim 1, wherein the plurality of fibers in the fiber batt consists essentially of post-consumer recycled PET.

11. The cushion carpet tile of claim 1, having a delamination strength of at least about 15 pounds/inch as measured by ASTM D3936-02.

12. A cushion carpet comprising:
a) a face fabric having a face side and a back side;
b) an adhesive composition comprising at least one laminating adhesive wherein the composition is adjacent to the back side of the face fabric; and
c) a modified secondary backing in contact with the adhesive composition, wherein the modified secondary backing comprises:
i) a scrim material having needle side and a top side; and
ii) a non-woven fiber batt comprising a plurality of fibers attached to and penetrating the scrim material,
wherein no more than about 10% of the plurality of fibers penetrate the scrim material so as to be in contact with the adhesive composition, and
wherein the cushion carpet has a delamination strength of at least about 20 lbs/in as measured by ASTM D3936-02.

13. The cushion carpet of claim 12, wherein no more than about 7% of the plurality of fibers penetrate the scrim material.

14. The cushion carpet of claim 12, wherein the laminating adhesive comprises one or more of: HBEP, MDPE, LDPE, LLDPE, HDPE, ULDPE, polyurethane, SBR, BDMMA, hot melt adhesive, polypropylene, VAE or bitumen.

15. The cushion carpet of claim 12, wherein the laminating adhesive comprises HBEP.

16. The cushion carpet of claim 12, wherein the adhesive composition is present at from about 10 to 80 oz/sy.

17. The cushion carpet of claim 12, wherein the scrim material comprises a leno weave material, woven material, knitted material, point bonded material or thermal fused material.

18. The cushion carpet of claim 12, wherein the plurality of fibers in the fiber batt comprises one or more of: polyester, polyethylene, nylon, natural fibers or polypropylene.

19. The cushion carpet of claim 12, wherein the plurality of fibers in the fiber batt consists essentially of post-consumer recycled PET.

20. The cushion carpet of claim 12, having a delamination strength of at least about 15 pounds/inch as measured by ASTM D3936-02.
